(19) United States
(12) Patent Application Publication
(10) Pub. No.: US 2019/0128789 A1
(43) Pub. Date: May 2, 2019

(54) SENSOR FOR THE DETECTION OF ELECTRICALLY CONDUCTIVE AND/OR POLARIZABLE PARTICLES, SENSOR SYSTEM, METHOD FOR OPERATING A SENSOR AND USE OF SUCH A SENSOR

(71) Applicant: Heraeus Sensor Technology GmbH, Hanau (DE)

(72) Inventors: Tim ASMUS, Allendorf-Winnen (DE); Karlheinz WIENAND, Aschaffenburg (DE); Stefan DIETMANN, Alzenau (DE); Martin KUNZ, Waldbronn (DE)

(73) Assignee: Heraeus Sensor Technology GmbH, Hanau (DE)

(21) Appl. No.: 16/096,836

(22) PCT Filed: Apr. 27, 2017
(86) PCT No.: PCT/EP2017/060037

§ 371 Date: Oct. 26, 2018

(30) Foreign Application Priority Data
Apr. 28, 2016 (DE) 10 2016 107 888.3

(51) Int. Cl. G01N 15/06

(52) U.S. Cl. CPC G01N 15/0656; G01N 2015/0046; G01N 15/0606

(57) ABSTRACT

One aspect relates to a sensor for the detection of electrically conductive and/or polarizable particles including a substrate, wherein on at least one side of the substrate in a first level a first structured insulator, in a second level a first structured electrode layer, in a third level a second structured insulator and in a fourth level a second structured electrode layer are either directly or indirectly arranged in such a way that in at least one structured electrode layer and/or a structured insulator at least one opening is formed, which is accessible to the particles to be detected, and wherein the electrode layers have at least two electrodes or at least two conductor tracks or a combination of at least one electrode and at least one conductor track.

The invention relates to a sensor for the detection of electrically conductive and/or polarizable particles, in particular for the detection of soot particles. The invention also relates to a sensor system, a method for operating a sensor and a use of such a sensor.

From the prior art sensors are known which have a sensor carrier, wherein electrodes and heating structures are arranged on this sensor carrier in a planar arrangement. In a detection operation, polarizable and/or electrically conductive particles are deposited on this planar arrangement. The deposited particles cause a reduction of the resistance between the electrodes, wherein this drop in resistance is used as a measure of the deposited particulate mass. After reaching a predefined threshold value of the resistance the sensor arrangement is heated with the heating structures, so that the deposited particles are burned off and after the cleaning process the sensor can be used for a further detection cycle.

In DE 10 2005 029 219 A1 a sensor for the detection of particles in an exhaust gas stream of internal combustion engines is described, wherein the structures of the electrodes, heaters and temperature sensors are applied to a sensor carrier in a planar arrangement. A disadvantage of this sensor arrangement is that the electrodes to be bridged must have a minimum length in order to arrive at an acceptable sensitivity range when measuring conductive and polarizable particles such as soot. This requires, however, a certain size of the sensor component in order to achieve the minimum length of the electrodes to be bridged. This results in corresponding cost disadvantages in the production of these sensor components.

The object of the invention is to specify a further developed sensor for the detection of electrically conductive and/or polarizable particles, in particular for the detection of soot particles, wherein the size of the sensor is minimized so that the above-mentioned disadvantages can be overcome.

Furthermore, the object of the present invention is to specify a sensor system, a method of operating a sensor and an improved use of such a sensor.

In accordance with the invention this object is achieved by a sensor for the detection of electrically conductive and/or polarizable particles, in particular for the detection of soot particles, in accordance with claim 1. With regard to the sensor system the object is achieved by the features of claim 12. With regard to the method for operating a sensor the invention, the object is achieved by the features of claim 13. With regard to a usage of a sensor, the object is achieved by the features of claim 15.

Advantageous and expedient embodiments of the sensor according to the invention or of the method according to the invention for operating a sensor or the use according to the invention of the sensor are specified in the dependent claims.

The idea underlying the invention is to specify a sensor for the detection of electrically conductive and/or polarizable particles, in particular for the detection of soot particles, comprising a substrate, wherein on at least one side of the substrate, in a first level a first structured insulator, in a second level a first structured electrode layer, in a third level a second structured insulator and in a fourth level a second electrode layer structure are either directly or indirectly arranged, in such a way that in at least one structured electrode layer and/or in a structured insulator at least one opening is formed which is accessible to the particles to be detected, wherein the electrode layers each have at least two electrodes or at least two conductor tracks or a combination of at least one electrode and at least one conductor track.

In other words, a sensor is provided, wherein at least one first and one second structured electrode layer are arranged horizontally one above another and at least one structured insulator is formed between the two structured electrode layers. At least one first structured insulator is located between the substrate and the first structured electrode layer of the second level.

In general, the substrate is designed in a planar form, so that it has at least two surfaces that are much larger than the other surfaces. Other forms are also possible, however, in which for example all surfaces are approximately the same size (cube, tetrahedron, etc.), or only one surface is greater than the other(s) (e.g. cylinder or hemisphere). The electrode or insulator layers are applied on at least one of the surfaces, but can also cover a plurality of surfaces. The thickness of the substrate can be several mm, and is preferably in a range from 0.2 mm to 0.5 mm, particularly preferably in a range from 0.3 mm to 0.4 mm.

The substrate can consist of an insulating or conducting or semi-conducting material. For example, metal oxides, glasses, ceramics and/or glass ceramics can be used as insulating materials. The materials used are preferably Al₂O₃ or ZrO₂ or MgO. The conductive materials used are the metals or alloys or conductive ceramics that have a melting point which is higher than the operating temperature. Nickel or nickel-iron alloys or aluminium or aluminium-chromium alloys are preferably used as conducting materials. Materials such as silicon or silicon carbide are suitable as semiconductors.

If a metal or a semiconductor is used as the substrate, one electrode layer can be saved, and the total thickness of the sensor can be reduced. This is particularly advantageous when additional layers are applied on both sides of the substrate. It is possible to implement the metal substrate as a conductor track and to use it as a heating conductor or temperature sensor. For this purpose, the spaces between the conductor tracks are filled and the conductor track sections are insulated from one another, preferably during the production of the insulator layer.

It is possible for the sensor to have more than four levels, so that the substrate can have other structured electrode layers and other structured insulators. In other words, a level with an odd number has a structured insulator, while an even-numbered level has a structured electrode layer. If more than two structured electrode layers are formed, the sensor is preferably always designed in such a way that one structured insulator is always formed between two structured electrode layers. The number of levels is calculated starting from the substrate, or from one side of the substrate.

The structured electrode layers are arranged on top of one another, in particular stacked on top of one another, wherein the structured electrode layers are spaced apart from one another in each case by means of at least one structured insulator.

The sensor according to the invention can comprise, for example, at least three structured electrode layers and at least three structured insulators, wherein one insulator is always formed between two structured electrode layers. A first structured insulator is preferably formed on one side of the substrate.

A structured insulator can consist of two or more sub-layers, which can be arranged side-by-side and/or on top of one another. Two or more sub-layers of a structured insulator can be composed of different materials and/or comprise different materials.

A structured electrode layer can consist of at least two electrodes or at least two conductor tracks or a combination of at least one electrode and at least one conductor track. An electrode layer can thus also have three electrodes or three conductor tracks or a combination of two electrodes and one conductor track. In addition, it is possible that the different electrode layers are each constructed differently. In other words, the at least two electrode layers can be formed from different numbers of electrodes and/or conductor tracks.

At least one electrode preferably layer has at least two interleaved electrodes, or at least two conductor tracks that are either interleaved or run parallel to each other at least in some regions, or a combination of at least one electrode and at least one conductor track which are interleaved or interwoven with one another. The interleaving can therefore be referred to as “interwoven with one another” or “nested with one another” or “intertwined with one another” or “interlaced with one another”.

The individual electrode layers used can have different structures.

It is also possible that electrode layers are formed such they are crossed over each other.

in other words, the sensor according to the invention can have a layer composite, which comprises at least two insulators and at least two structured electrode layers.

Furthermore, it is possible that between the electrodes and/or conductor tracks, overlapping openings are formed through at least two levels, wherein the openings are accessible to the particles to be detected. In other words, a plurality of layers of the substrate, in particular a plurality of structured electrode layers and/or a plurality of structured insulators, have openings, wherein the openings are arranged on top of one another in such a way that a particle can penetrate into an opening of a structured electrode layer located further down. The openings can also pass through the substrate and also merge with openings of other electrodes and insulator layers (levels) on the other side. The openings are generally arranged above one another, so that passages are produced, which extend over a plurality of levels. However, the openings can also be arranged at least in some portions of the sensor in such a way that they are only partially above one another or not at all.

Preferably, the opening of at least one electrode layer is spaced apart from the edge region of this electrode layer and the opening of at least one insulator is spaced apart from the edge region of the insulator. The openings are therefore preferably not formed in the boundary layers or not at the lateral edges of the relevant layers.

The first structured electrode layer and the second structured electrode layer are insulated from each other by the second structured insulator located between them. As a result of such a design, a very sensitive sensor can be formed, which has a smaller overall size in comparison to sensors from the prior art.

In a further embodiment of the invention, a third structured insulator can be formed in a fifth level.

Furthermore, it is possible that in a/the fifth level a third structured insulator and in a sixth level at least a third structured electrode layer is formed, with at least two electrodes or at least two conductor tracks or a combination of at least one electrode and at least one conductor track.

In addition to the construction of a fifth level and/or a sixth level, it is possible that other structured insulators and other structured electrode layers are formed in other levels, wherein the electrode layers can each have at least two electrodes or at least two conductor tracks or a combination of at least one electrode and at least one conductor track.

A/the structured insulator can have, at least in some sections, the structure of a structured electrode layer arranged thereon, in particular of electrodes and/or conductor tracks arranged thereon. Furthermore, it is possible that a/the structured insulator, at least in some sections, has the structure of a structured electrode layer arranged thereunder, in particular of electrodes and/or conductor tracks arranged thereunder.

Between the substrate and the first structured insulator or between the substrate and the first level with a first structured insulator an electrically conductive layer, in particular a flat metallic layer, can be constructed which covers the substrate, in particular in the area of the openings. The flat metallic layer can be structured, but preferably has no openings or passages.

At least one structured insulator can have a thickness of 0.1 μm to 50 μm, in particular of 1.0 μm to 40 μm, in particular of 5.0 μm to 30 μm, in particular of 7.5 μm to 20 μm, in particular from 8 μm to 12 μm. By varying the thickness of the structured insulator, the distance from one first electrode layer to another electrode layer can be adjusted. The sensitivity of the sensor can be increased by reducing the spacing of the structured electrode layers located on top of one another. The lower the thickness that the insulator is designed, the more sensitive is the sensor.

Furthermore, it is possible that the thickness(es) of the electrode layer(s) and/or the thickness(es) of the insulator/insulators of a substrate varies/vary.

It is possible that the insulators have different layer thicknesses. The distances between the electrode layers can therefore vary. By using different layer thicknesses of the insulators, the size of the detected particles can be measured. In addition, it is possible to infer a particle size distribution of the detected particles based on the different layer thicknesses of the insulators.

At least one structured insulator can be formed of aluminium oxide (Al₂O₃) or silicon dioxide (SiO₂) or magnesium oxide (MgO) or silicon nitrite (Si₃N₄) or glass or ceramic or glass ceramic or metal oxide, or any mixture thereof.

It is possible that at least one structured insulator laterally encloses at least one structured electrode layer located underneath it. In other words, this insulator can cover the side faces of the electrode layer in such a way that this electrode layer is insulated laterally.

At least one conductor track can be formed between the substrate and the first structured insulator and/or on another side of the substrate and/or in an even-numbered level as a heating conductor.

At least one electrode and/or at least one conductor track can consist of a conductive material, in particular of metal or an alloy, in particular from a high temperature-resistant metal or a high temperature-resistant alloy, particularly preferably from a metal of the group of platinum metals or from an alloy of a metal of the group of platinum metals. The elements of the platinum group of metals are palladium (Pd), platinum (Pt), rhodium (Rh), osmium (Os) and Iridium (Ir). Non-precious metals such as Nickel (Ni) or non-precious metal alloys such as nickel/chromium or nickel/iron can also be used.

In addition, it is possible that at least one electrode and/or at least one conductor track is formed from a conductive ceramic or a mixture of metal and ceramic. For example, at least one electrode layer can be formed from a mixture of platinum (Pt) grains and aluminium oxide (Al₂O₃) bodies. It is also possible that at least one actual electrode and/or at least one conductor track comprises silicon carbide (SiC) or is made from silicon carbide (SiC). The above-mentioned materials and metals or alloys of these metals are particularly highly temperature resistant and are therefore suitable for constructing a sensor element that can be used for the detection of soot particles in an exhaust gas flow of internal combustion engines.

The thickness of the electrodes or conductor tracks can vary over a wide range, and thicknesses in a range from 10 nm up to 1000 μm can be used. Preferably, thicknesses in the range of 100 nm to 100 μm, particularly preferably in the range of 0.6 μm to 1.2 μm, and quite particularly preferably from 0.8 μm to 0.9 μm are used.

The width of the electrodes or conductor tracks can vary over a wide range, with widths in a range of 10 μm to 10 mm being used. Preferably, widths from 30 μm to 300 μm, particularly preferably from 30 μm to 100 μm and quite particularly preferably from 30 μm to 40 μm are used.

On the side of the topmost structured electrode layer facing away from the first structured insulator, at least one covering layer can be constructed, which is formed in particular from ceramic and/or glass and/or metal oxide or any combination thereof. In other words, the at least one covering layer is constructed on a side of the topmost electrode layer which is formed opposite to the first structured insulator. The covering layer can act as a diffusion barrier and additionally reduces an evaporation of the electrode layer or topmost electrode layer, or the electrode layer with the highest even-numbered level. This is important particularly at high temperatures above 700° C. In an exhaust gas stream, for example, temperature up to 850° Celsius and higher can be reached.

In a further embodiment of the invention, the covering layer can additionally laterally enclose the top-most insulator and/or other electrode layers. In other words, both the side faces of the top-most electrode layer and the side faces of the underlying insulators can be covered with at least one covering layer. The lateral enclosing part or the lateral enclosing region of the covering layer can therefore extend from the topmost electrode layer as far as the bottom electrode layer. This provides a lateral insulation of the electrode layer(s) and/or the insulator/insulators.

It is possible that at least one covering layer does not completely cover the topmost electrode layer. In other words, it is possible that at least one covering layer only covers the topmost electrode layer in some sections.

If the topmost electrode layer is designed as a heating layer, it is possible that only the sections of the heating loop/heating coil are covered by the at least one cover layer. The topmost electrode layer is defined as the electrode layer that is arranged furthest away from the substrate. The bottom electrode layer is defined as the electrode layer arranged closest to the substrate. The topmost insulator is defined as the insulator which is spaced furthest apart from the substrate. The bottom insulator is defined as the insulator which is formed closest to the substrate.

A porous filter layer can be formed on the topmost electrode layer and/or on the covering layer. Using such a porous filter layer allows larger particle fragments to be kept away from the arrangement of electrode layers and insulators. At least one of the pores or plurality pores of the filter layer are designed in such a way that they guarantee a passage through the filter layer, which particles of the appropriate size can pass through. The pore size of the filter layer can be, for example, >1 μm. The porous filter layer can also be a micro-structured layer, in which openings with a defined size are present or are created.

Particularly preferably, the pore size is designed in a range of 20 μm to 30 μm. The porous filter layer can be formed, for example, from a ceramic material. It is also conceivable for the porous filter layer to be made of an aluminium oxide foam. The filter layer, which also covers the opening(s) of the sensor, enables the large particles, in particular soot particles, which interfere with the measurement to be kept away from the at least one passage, so that such particles cannot cause a short circuit.

The sensor has at least one opening. At least one opening of the sensor can be designed as a blind hole, wherein a section of the first insulator or a section of the first structured electrode layer or a section of the optional flat metallic layer is formed as the base of the blind hole. If the sensor has a covering layer, the opening also extends through this covering layer. In other words, both the electrode layers as well as the insulators and the cover layer then each have an opening, wherein these openings are arranged on top of one another in such a way that they form a passage, in particular a blind hole or a longitudinal depression, the base of which is formed by a section of the bottom electrode layer or a section of the bottom insulator or a section of the flat metal layer. The floor of the opening, in particular of the blind hole or the longitudinal depression, can be formed, for example, on the upper side of the first electrode layer facing the first insulator. Furthermore, it is conceivable that the first electrode layer has a depression, which forms the base of the blind hole or the longitudinal depression.

The at least one opening of the sensor can have a linear or meandering shape or the shape of a lattice or spiral.

The at least one opening, in particular at least one longitudinal depression, can have a V-shaped and/or U-shaped cross-section and/or a semi-circular and/or a trapezoidal cross-section, at least in some sections.

For example, the cross-section of the opening of a blind hole, for example, can be round or square or rectangular or oval-shaped or honeycomb shaped, polygonal or triangular or hexagonal. Different types of configurations, in particular free forms, are also conceivable.

For example, it is possible that the blind hole has a square cross-section with an area of 3×3 μm² to 150×150 μm², in particular of 10×10 μm² to 100×100 μm², in particular of 15×15 μm² to 50×50 μm², in particular of 20×20 μm².

In a further extension of the invention, the sensor can have a plurality of passages or openings, in particular a plurality of blind holes and/or longitudinal depressions, wherein these blind holes and/or longitudinal depressions can be designed as already described. In addition, it is possible that at least two passages, in particular two blind holes and/or two longitudinal depressions, have different cross-sections, in particular cross-sections of different sizes, so that a sensor array with a plurality of fields can be formed in which a plurality of measuring cells with different sizes of blind hole cross-sections and/or different sizes of depression cross-sections can be used. Through parallel detection of electrically conductive and/or polarizable particles, in particular of soot particles, additional information on the size of the particles or the size distribution of the particles can be obtained.

The sensor comprises, for example, a plurality of passages in the form of longitudinal depressions, wherein the passages are arranged in the manner of a grid.

At least one passage, in particular a longitudinal depression, can have a V-shaped and/or a U-shaped cross-section and/or a semi-circular and/or a trapezoidal cross section, at least in some sections.

Such cross-sections or cross-sectional profiles improve the measurement of round particles. In addition, the golf ball effect is avoided by using these types of cross-section or cross-sectional profile.

The longitudinal depression can also be referred as a trench and/or groove and/or channel.

In a further embodiment of the invention it is possible that the sensor comprises both at least one passage in the form of a blind hole, which is round or square or rectangular or oval-shaped or honeycomb-shaped or polygonal or triangular or hexagonal, and at least one passage in the form of a longitudinal depression, which in particular has a linear or meandering shape, or the shape of a lattice or spiral.

The width of the longitudinal depression at the topmost edge of the depression can be in the range from 0.1 μm to 500 μm, preferably from 1 μm to 200 μm, particularly preferably in the range from 4 μm to 100 μm. The width of the longitudinal depressions in the vicinity of the first electrode layer can be in the range from 0.1 μm to 200 μm, preferably in the range of 0.1 μm to 100 μm, particularly preferably in the range from 1 μm to 50 μm. The width of the longitudinal depressions can vary and it is possible to change the width of different sections of a sensor. This also enables conclusions to be drawn as to the size of the measured particles, because large particles, for example, cannot enter narrow depressions.

The depth of the openings or passages depends on the number of levels and the thickness of the layers. The thickness is in the range from 100 nm to 10 mm, preferably in the range from 30 μm to 300 μm, particularly preferably in the range from 30 μm to 100 μm. The depth of the openings and passages is in general identical for all openings on a sensor, but it can also vary and may be different in different areas of the sensor.

If a plurality of passages in the form of longitudinal depressions are formed in a sensor, these can be designed to be oriented in one or more preferential directions.

In one embodiment of the invention it is possible for at least one opening of an insulator to form an undercut and/or a recess. In other words, the insulator can be offset back, or recessed, relative to an electrode layer arranged above and one arranged below the insulator. A lateral recess in the opening of an insulator can also be designed round and/or V-shaped. The formation of an undercut or an insulator recessed in the passage improves the measurement of round particles. In such an embodiment of the invention particles, in particular round particles, are fed to the electrode layer, and in particular to an electrode and/or to a conductor track, in a manner which allows a good electrical contact. In other words, the opening of at least one insulator can be larger than the opening of the electrode layers arranged above and below the insulator.

At least one structured electrode layer can have an electrical contacting surface which is free of sensor layers arranged above the structured electrode layer, and is or can be connected to a terminal pad. The electrode layers are or can be connected to terminal pads such that they are insulated from each other. Preferably, for each electrode layer or each electrode and/or each conductor track of an electrode layer at least one electrical contacting surface is formed, which is exposed in the area of the terminal pads to allow electrical contacting. The electrical contacting surface of the bottom electrode layer, i.e. of the bottom electrodes and/or bottom conductor tracks, is free of any possible covering layer and free of insulators, free of additional electrode layers and, if appropriate, porous filter layers. In other words, no section of an insulator nor any section of an electrode layer is located above the electrical contacting surface of the bottom electrode layer, i.e. the bottom electrode(s) and/or the bottom conductor track(s).

The statements relating to the contacting surface in connection with the first electrode layer also apply to electrode layers located above them, wherein these contacting surfaces are then free of any sensor layers located above each electrode layer concerned.

In a further embodiment of the invention at least the first structured electrode layer and/or the second structured electrode layer have conductor track loops, in such a way that the first electrode layer and/or the second electrode layer is/are designed as a heating coil and/or as a temperature-sensitive layer and/or as a screen electrode. It is also possible that one electrode layer, in particular an electrode and/or a conductor track of the electrode layer, may have two electrical contacting surfaces. These types of electrode layers can be used both as a heating coil as well as a temperature-sensitive layer and as a screen electrode. By means of appropriate electrical contacting of the electrical contacting surface, the relevant electrode layer can either be used for heating or as a temperature-sensitive layer or screen electrode. Such a design of the electrode layer(s) enables compact sensors to be provided, since an electrode layer, or the at least two electrodes, or at least two conductor tracks or a combination of at least one electrode and at least one conductor track of the relevant electrode layer can perform a plurality of functions. No separate heating coil layers and/or temperature-sensitive layers and/or screening electrode layers are therefore necessary.

When heating the at least one electrode layer, measured particles and/or the particles present in the sensor openings can be burned away or burned off.

In summary, it can be stated that the design according to the invention allows a very accurate measuring sensor to be provided. By constructing one or more thin insulation layer(s) the sensitivity of the sensor can be substantially increased.

In addition, the construction of the sensor according to the invention can be much smaller than that of known sensors. By designing the sensor in a three-dimensional space, a plurality of electrode layers and/or a plurality of insulators can be assembled as a smaller sensor. Furthermore, during the production of the sensor significantly more units can be constructed on a substrate or a wafer.

The sensor according to the invention can be used for the detection of particles in gases. The sensor according to the invention can be used for the detection of particles in liquids. The sensor according to the invention can be used for the detection of particles in gases and liquids and/or gas-liquid mixtures. In the use of the sensor for the detection of particles in liquids it is recognized that it is not always possible to burn off or burn away the particles. It is possible, however, to remove the liquid in order then to burn off the particles and thereafter to expose the sensor to the liquid to be measured again.

According to a further aspect the invention relates to a sensor system, comprising at least one sensor according to the invention and at least one circuit, in particular at least one control circuit, which is designed in such a way that the sensor can be operated in a measurement mode and/or a cleaning mode and/or in a monitoring mode.

The sensor according to the invention and/or the sensor system according to the invention can have at least one auxiliary electrode. Between an auxiliary electrode and a structured electrode layer and/or between an auxiliary electrode and a component of the sensor system, in particular the sensor housing, an electric potential can be applied of such a kind that the particles to be measured are electrically attracted or sucked in by the sensor and/or the sensor system. Preferably, such a voltage is applied to the at least one auxiliary electrode and to at least one structured electrode layer that particles, in particular soot particles, are “sucked into” at least one opening of the sensor.

The sensor according to the invention is preferably arranged in a sensor housing. The sensor housing can have, for example, an elongated tubular shape. The sensor system according to the invention can therefore also comprise a sensor housing.

The sensor and/or the sensor in the sensor housing and/or the sensor housing are preferably designed and/or arranged such that the sensor, in particular the topmost (electrode) layer of the sensor or the layer that is furthest from the substrate, is inclined with respect to the flow direction of the fluid. The flow therefore does not impinge on the plane of the electrode layers at right angles. Preferably, the angle α between the normal to the plane of the topmost electrode layer and the flow direction of the particles is at least 1°, preferably at least 10°, particularly preferably at least 30°. Furthermore, the orientation of the sensor is one in which the angle ß between the flow direction of the particles and the preferred axis of the electrodes or loops is preferably between 20° and 90°. In this embodiment the particles to be detected can more easily enter the openings, in particular the blind holes or longitudinal depressions of the sensor, and thereby increase the sensitivity.

The circuit, in particular the control circuit, is preferably designed in such a way that the structured electrode layers and/or the corresponding electrodes and/or conductor tracks are interconnected. Different voltages can be applied to the electrode layers and/or individual electrode layers in such a way that the sensor can be operated in a measurement mode and/or a cleaning mode and/or in a monitoring mode.

In accordance with a subsidiary aspect, the invention relates to a method for controlling a sensor according to the invention and/or a sensor system according to the invention.

As a result of the method according to the invention, the sensor can be operated either in a measurement mode and/or a cleaning mode and/or a monitoring mode.

In the measurement mode, a change in the electrical resistance between the electrode layers and/or between the electrodes and/or conductor tracks of the electrode layers of the sensor and/or a change in the capacitances of the electrode layers can be measured.

In other words, in the measurement mode, a change in the electrical resistance between the electrodes and/or conductor tracks of one level of the sensor and/or a change in the capacitances of the electrodes and/or conductor tracks of one level of the sensor is/are measured.

It is possible that in the measurement mode a change in the electrical resistance between the electrodes or conductor tracks of at least two levels of the sensor and/or a change in the capacitance of the electrodes and/or conductor tracks of at least two levels of the sensor is/are measured.

By means of the method according to the invention, particles can be detected or measured based on a measured change in resistance between the electrode layers and/or the electrodes and/or the conductor tracks of both one and of a plurality of electrode layers. Alternatively or additionally, particles can be detected or measured based on a measured change of impedance and/or by measuring the capacitance of the electrode layer(s) and/or the electrode(s) and/or the conductor track(s) of one or more electrode layers. A change in resistance between electrode layers is preferably measured.

In the measurement mode, an electrical resistance measurement, i.e. a measurement according to the resistive principle, can be carried out. In this method, the electrical resistance between two electrode layers is measured, wherein the electrical resistance decreases when a particle, in particular a soot particle, bridges across at least two electrode layers and/or at least two electrodes and/or at least two conductor tracks, which act as electrical conductors.

The basic principle that applies in the measurement mode is that by applying different voltages to the electrode layers and/or to the electrodes and/or the conductor tracks, different properties of the measured particles, in particular soot particles, can be detected. For example, the particle size and/or the particle diameter and/or the electrical charge and/or the polarizability of the particle can be determined.

If at least one electrode layer or at least one electrode or at least one conductor track is used as a heating coil or heating layer, or can be connected as such, an electrical resistance measurement can additionally be used to determine the time of activation of the heating coil or heating layer. The activation of the heating coil or heating layer corresponds to a cleaning mode to be carried out.

Preferably, a decrease in the electrical resistance between at least two electrode layers and/or between at least two electrodes and/or between at least two conductor tracks and/or between a combination of an electrode and a conductor track, indicates that particles, in particular soot particles, have been deposited on or between the electrode layers and/or electrodes and/or conductor tracks. As soon as the electrical resistance reaches a lower threshold value, the heating coil or heating layer is activated. In other words, the particles are burned off. The electrical resistance increases with an increasing number of burned off particles or volume of burned off particles. The burning off is preferably carried out for a long enough time for an upper electrical resistance value to be measured. When an upper electrical resistance value is reached this indicates a regenerated or cleaned sensor. Thereafter, a new measurement cycle can then be started or carried out.

Alternatively or in addition, it is possible to measure a change in the capacitances of the electrode layers and/or the electrodes and/or the conductor tracks and/or a combination of at least one electrode and at least one conductor track. An increasing loading with particles, in particular soot particles, leads to an increase in the capacitance of the electrode layers and/or electrodes and/or conductor tracks. The occupation of the sensor with particle leads to a charge displacement or a change in the permittivity (ε), which leads to an increase in capacitance (C). The following fundamental relation applies: C=(ε×A)/d, where A represents the active electrode area of the electrode layer and/or electrode and/or conductor track, and d represents the distance between two electrode layers and/or electrodes and/or conductor tracks.

The measurement of the capacitance can be carried out, for example, by:
determining the rate of voltage increase for a constant current and/or
applying a voltage and determining the charging current and/or
applying an AC voltage and measuring the current waveform and/or
determining the resonant frequency by means of an LC resonant circuit.

The described measurement of the change in the capacitances of the electrode layers can also be used in conjunction with a monitoring mode to be carried out.

In accordance with the OBD (On Board Diagnostics) regulation, all emissions-related parts and components are required to be checked for correct functioning. The functional check must be performed, for example, directly after starting a motor vehicle.

For example, at least one electrode layer may be damaged, which is associated with a reduction in the active electrode surface area A. As the active electrode surface A is directly proportional to the capacitance C, the measured capacitance C of a damaged electrode layer or a damaged electrode or a damaged conductor track decreases.

In the monitoring mode, it is alternatively or additionally possible to design the electrode layers and/or electrodes and/or conductor tracks as conductor circuits. The conductor circuits can be designed as closed or open conductor circuits, which if necessary can be closed, for example by means of a switch.

In addition, it is possible to close the electrode layers or the electrodes and/or the conductor tracks using at least one switch to form at least one conductor circuit, while in the monitoring mode, a check is made to determine whether a test current is flowing through the at least one conductor circuit. If an electrode layer, in particular an electrode or a conductor track, has a crack or has suffered damage or is destroyed, either no or only a very small test current would flow.

In accordance with other aspects of the invention, a plurality of uses of a sensor according to the invention are particularly preferred. In accordance with dependent claim 15 a use according to the invention of a sensor relates to the detection of electrically conductive and/or polarizable particles, in particular the detection of soot particles.

A further aspect of the invention relates to the use of a sensor according to the invention for the detection of electrically conductive and/or polarizable particles, in particular for the detection of soot particles, wherein the flow direction of the particles does not impinge perpendicularly on the plane of the structured electrode layer.

A further aspect of the invention relates to the use of a sensor according to the invention for the detection of electrically conductive and/or polarizable particles, in particular for the detection of soot particles, wherein the angle α between the normal to the plane of the topmost structured electrode layer and the flow direction of the particles is at least 1°, preferably at least 10°, particularly preferably at least 30°.

A further aspect of the invention relates to the use according to the invention of a sensor for the detection of electrically conductive and/or polarizable particles, in particular for the detection of soot particles, wherein the angle ß between the flow direction of the particles and the preferential direction of an electrode and/or a conductor track is between 20° and 30°. The preferential direction of an electrode and/or a conductor track and/or a loop is understood to mean the axis in which the electrode and/or the conductor track and/or the loop primarily extends. Conductor track loops and/or electrodes therefore have a main preferential direction. Hereinafter, the invention is described in greater detail based on exemplary embodiments and with reference to the appended schematic drawings.

These show:

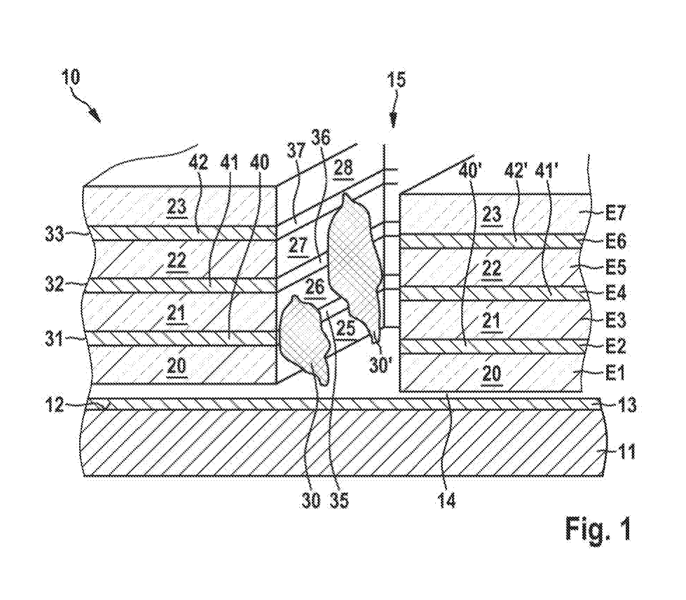

FIG. 1: a cross-sectional view of a first embodiment of a sensor according to the invention for the detection of electrically conductive and/or polarizable particles;

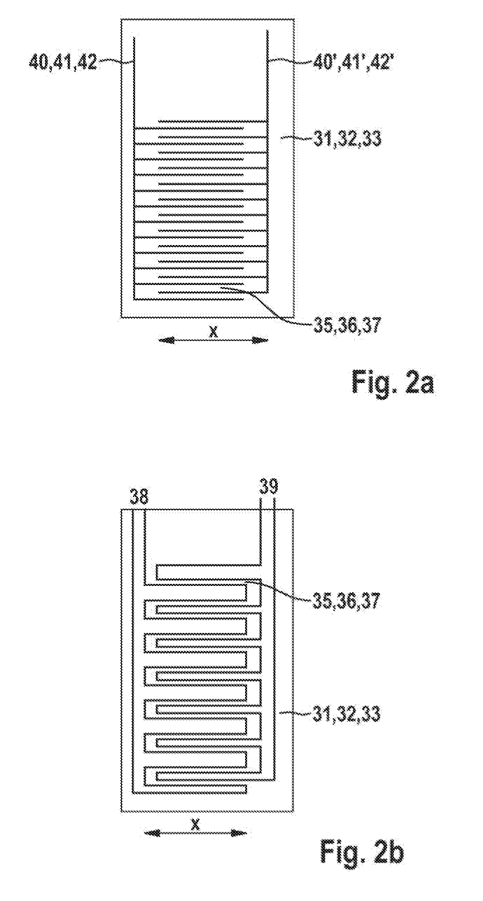

FIGS. 2a+2b: illustrations of possible electrode layers;

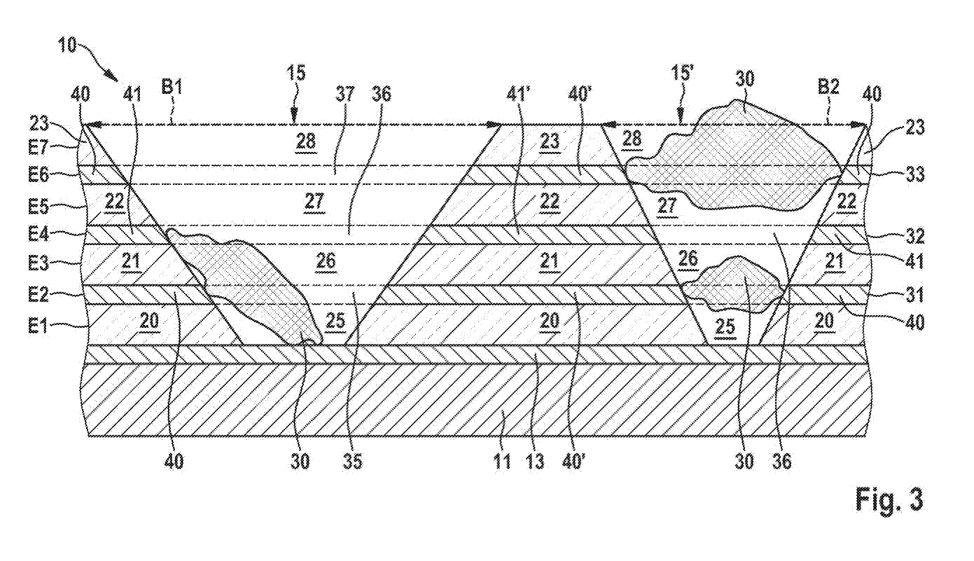

FIG. 3: illustration of various cross-sectional sizes of passages;

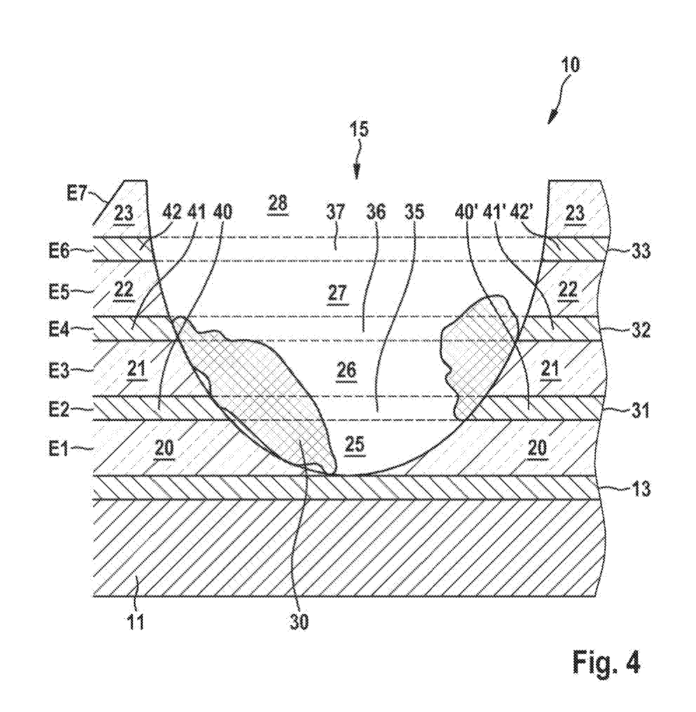

FIG. 4: illustrations of a further cross-sectional profile of a possible passage in the sensor;

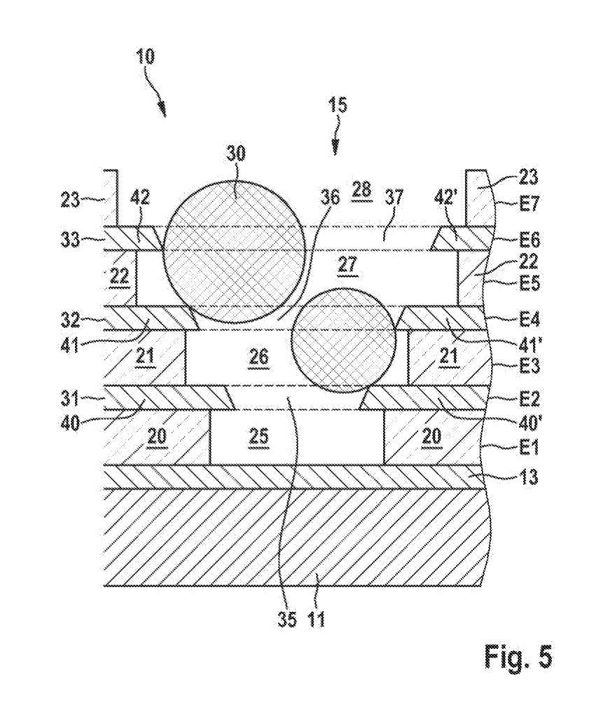

FIGS. 5+6: cross-sectional view of undercuts in insulators or recessed insulators; and

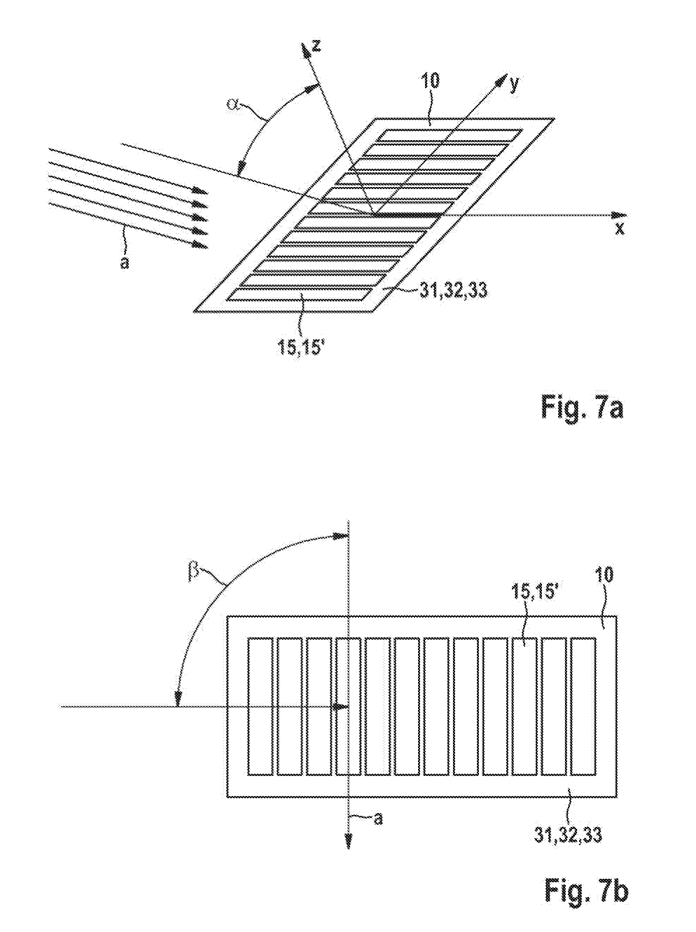

FIGS. 7a+7b: illustration of a possible arrangement of a sensor in a fluid flow.

In the following, identical reference numerals are used for identical or functionally equivalent parts.

FIG. 1 shows a section through a sensor 10 for the detection of electrically conductive and/or polarizable particles, in particular for the detection of soot particles. The sensor 10 can in principle be used for the detection of particles in gases and liquids.

The sensor 10 comprises a substrate 11 and a layer composite formed above the substrate 11, in particular on the first side 12 of the substrate 11. On the first side 12 of the substrate 11 an electrically conductive layer 13, in particular a planar metallic layer, is formed. Above this electrically conductive layer 13 a plurality of levels is formed, in particular seven levels E1, E2, E3, E4, E5, E6 and E7. In a first level E1 a first structured insulator 20 is formed. In the second level E2 a first structured electrode layer 31 is formed, wherein the first structured electrode layer 31 is formed from a first electrode 40 and a second electrode formed 40′. Structured insulators are formed in turn in the third level E3, in the fifth level E5 and in the seventh level E7, namely the structured insulator 21, the structured insulator 22 and the structured insulator 23. In the fourth level E4 the second electrode layer 32 is formed. The second electrode layer 32 consists of the first electrode 41 and the second electrode 41′. In the sixth level E6 a third electrode layer 33 is formed. The third electrode layer 33 consists of the first electrode 42 and the second electrode 42′.

The insulators 20, 21, 22 and 23 are therefore formed in the odd-numbered levels, namely in levels E1, E3, E5 and E7. In the even-numbered levels, namely in the levels E2, E4 and E6, electrode layers are formed, namely the first electrode layer 31, the second electrode layer 32 and the third electrode layer 33. Between the electrode layers 31, and 33, the insulators 21 and 22 are formed. In addition, the first structured insulator 20 is formed between the first electrode layer 31 and the substrate 11. The topmost, i.e. the third electrode layer 33, is again covered by the fourth insulator 23.

The sensor 10 comprises three electrode layers 31, 32 and 33 and four insulators 20, 21, 22 and 23.

The spacing between the electrode layers 31, 32 and 33 is determined by the thickness of the insulators 21 and 22. The thickness of the insulators 21 and 22 can be 0.1 μm to 50 μm. The sensitivity of the sensor 10 according to the invention can be increased by reducing the thickness of the insulators 21 and 22.

The electrode layers 31, 32 and 33 each have at least two electrodes 40 and 40′, or 41 and 41′ or 42′ and 42′. These electrodes are interlaced with each other in accordance with the invention.

Openings 25, 35, 26, 36, 27, 37 and 28 are formed in the first insulator 20, in the first electrode layer 31, in the second insulator 21, in the second electrode layer 32, in the third insulator 22, in the third electrode layer 33 and in the fourth insulator 23.

The opening 25 of the first insulator 20, the opening 35 of the first electrode layer 31, the opening 26 of the second insulator 21, the opening 36 of the second electrode layer 32, the opening 27 of the third insulator 22, the opening 37 of the third electrode layer 33 and the opening 28 of the fourth insulator 23 are arranged on top of one another in such a way that a passage 15 is formed. The openings 25, 26, 27, 28, 35, 36 and 37 are accessible for particles 30, 30′ to be detected. In the exemplary embodiment shown, two particles 30, 30′ are resting on the first side 14 of the electrically conducting layer 13. The first side 14 of the electrically conducting layer 13 faces away from the substrate 11. The first insulator 20 is mounted on the first side 14 of the electrically conducting layer 13.

The perspective section through the passage 15 shows that the particles 30, 30′ are resting on the first side 14 of the electrically conducting layer 13. The first side 14 thus forms the base of the passage 15. The small particle in the example shown is only touching the first electrode layer 31, in particular the first electrode 40 of the first electrode layer 31. The larger particle 30′ is touching both the first electrode layer 31 and the second electrode layer 32 and the third electrode layer 33. Also, the large particle 30′ is only touching each of the first electrodes 40, 41 and 42 of the electrode layers 31, 32 and 33. If the detection of particles is performed on the basis of the resistive principle, the resistance between the electrode layers 31, 32 and 33 is measured, wherein this resistance decreases if the particle 30 bridges across, for example, the first electrode layer 31, the second electrode layer 32 and the third electrode layer 33. The particle 30′ bridges across more electrode layers than the small particle 30. The particle 30′ is detected as a larger particle compared to the particle 30.

By applying different voltages to the electrode layers 31, 32 and 33, or to the respective first electrodes 40, 41 and 42 or the respective second electrodes 40′, 41′ and 42′, different particle properties, in particular different soot properties such as the diameter and/or size of the (soot) particle and/or the charge on the (soot) particle and/or the polarizability of the (soot) particle, can be measured.

For the purposes of a high-temperature compatible application, the substrate 11 is formed, for example, of aluminium oxide (Al₂O₃) or magnesium oxide (MgO) or from a titanate or a steatite.

The electrode layers 31, 32 and 33 and/or the respective electrodes 40, 40′, 41, 41′, 42, 42′ can be formed, for example, of platinum and/or a platinum-titanium alloy (Pt—Ti).

The insulators 20, 21, 22 and 23 preferably consist of a temperature-resistant material with high insulation resistance. For example, the insulators 20, 21, 22 and 23 can be made of aluminium oxide (Al₂O₃) or silicon dioxide (SiO₂) or magnesium oxide (MgO) or silicon nitride (Si₃N₄) or glass.

The sensor 10 shown, on the basis of the material selection of the individual layers and insulators, is suitable for high-temperature applications up to 860° C., for example. The sensor 10 can therefore be used as a soot particle sensor in the exhaust gas flow of an internal combustion engine. In an alternative embodiment of the invention it is conceivable that the electrode layers 31, 32 and 33 are each formed of a combination of at least one electrode and at least one conductor track.

In FIG. 2a a plan view of a possible embodiment of the electrode layers 31, 32 and 33 is shown. The electrode layers each comprise one first electrode 40, 41 or 42 and one second electrode 40′, 41′ and 42′. The electrodes are designed to be interleaved. It is also conceivable that the electrodes are designed to be interwoven into or with each other. A mutually interlaced condition or design of the electrodes is also possible. The openings 35, 36 and 37 of the electrode layers 30, 31 and 32 are also shown schematically. The openings are implemented in the form of elongated holes. If more than one such openings are arranged on top of one another, wherein the insulators also have similar opening geometries, longitudinal depressions can be formed. A preferential axis x is obtained, in which the electrodes are aligned.

FIG. 2b shows a further embodiment with regard to the structure of the electrode layers 31, 32 and 33. These electrode layers have at least two conductor tracks, namely a first conductor track 38 and a second conductor track 39. The conductor tracks 38 and 39 form conductor track loops. These conductor track loops are also interlaced with each other, and in large areas run parallel to each other. Between the conductor tracks 38 and 39 further openings are formed, which can also be referred to as elongated openings. In this context also, a preferential axis x of the conductor track loops is formed.

In each of FIGS. 3 to 6 a cross-section is shown which is taken perpendicular to the sensor 10, thus starting from the topmost insulator 20 towards the substrate 11. The sensors 10 of FIGS. 3 to 6 have seven levels, namely the levels E1 to E7. In the levels E1, E3, E5 and E7 insulators 20, 21, 22 and 23 respectively are formed. In the levels E2, E4 and E6 electrode layers 31, 32 and 33 respectively are formed, each with two electrodes, namely the electrodes 40, 40′, 41, 41′ and 42, 42′.

In the sensor 10 according to FIG. 3, the cross-sectional profiles of two passages are shown in the form of longitudinal depressions 15 and 15′. The two passages 15 and 15′ have V-shaped cross-sections. The opening sizes and/or opening cross-sections decrease from the fourth insulator 23 towards the substrate 11, in particular towards the electrically conducting layer 13. The cross-sections of the openings 28, 37, 27, 36, 26, 35 and 25 reduce in size starting from the first opening cross-section of the opening 28 towards the bottom cross-sectional opening of the opening 25.

In addition, FIG. 3 shows that the passages 15 and 15′ can have different widths. The left-hand passage 15 has a width B1. The right-hand passage 15′ has a width B2. B1 is greater than B2. The design of the passages 15 and 15′ with different widths enables size-specific measurements of the particles 30 to be carried out.

The V-shaped cross-sectional profiles allow the measurements of round particles to be improved.

In FIG. 4 an example is given illustrating the fact that in an alternative embodiment a longitudinal depression 15 can have a U-shaped cross-section or a U-shaped cross-sectional profile. The opening sizes and/or opening cross-sections decrease from the fourth insulator 23 in the direction of the electrically conducting layer 13. The cross-sections of the openings 28, 37, 27, 36, 26, 35 and 25 reduce in size starting from the first opening cross-section of the opening 28 towards the bottom cross-sectional opening of the opening 25. The use of a U-shaped cross-sectional profile can in turn improve the measurement of round particles.

FIG. 5 shows recessed insulators 20, 21, 22 and 23 in cross-section. In the case of round particles the formation of flat or smooth passage surfaces is unfavourable. The formation of recessed or undercut insulators 20, 21, 22 and enables the measurement of round particles to be improved. The insulators 20, 21, 22 and 23 are recessed compared to the electrode layers 31, 32 and 33. Each of the openings 28, 27, 26 and 25 of an insulator 23, 22, 21 and 20 is larger than an opening 35, 36 and 37 formed above it of an electrode layer 31, 32 and 33 arranged above the respective insulator. The cross-sectional profile of the passage 15 has a V-shaped design, wherein the openings of all layers 23, 33, 22, 32, 21, 31 and 20 become smaller in the direction of the substrate 11, so that the openings 25, 26, 27 and 28 of the insulators 20, 21, 22 and 23 do not have the same sizes.

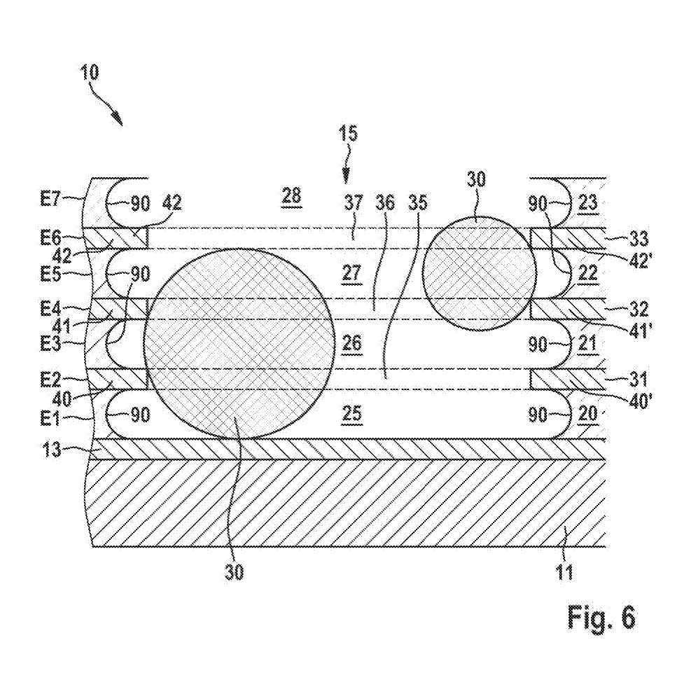

FIG. 6 shows a cross-sectional view of undercuts in the insulators 20, 21, 22 and 23. It is also the case in this connection that the design of undercuts in the insulators enables the measurement of round particle to be improved. The insulators 20, 21, 22 and 23 have undercuts or recesses 90. The sizes of the openings 25, 26, 27 and 28 of the insulators 20, 21, 22 and 23 are therefore larger than the openings 35, 36 and 37 of the electrode layers 31, 32 and 33.

As shown in FIG. 7a, a sensor 10 is introduced into a fluid flow in such a way that the flow direction a of the particles does not impinge perpendicularly on the plane (x,y) of the electrode layers 31, 32, 33. The angle α between the normal (z) to the plane (x, y) of the topmost electrode layer 33 and the flow direction a of the particles is at least 1 degree, preferably at least 10 degrees, particularly preferably at least 30 degrees. The particles can therefore be more easily passed into the openings or passages 15, 15′ and therefore more easily to the walls of the openings of the electrode layers 30, 31 and 33 formed therein.

In FIG. 7b a sensor 10 is introduced in a fluid flow in such a way that the angle □ between the flow direction a of the particles and the preferential axes x (for which see the preferential axes of FIGS. 2a and 2b) of the electrodes and/or conductor tracks is between 20 and 90 degrees.

At this point it should be noted that all of the elements and components described above in connection with the embodiments in accordance with FIG. 1 to FIG. 7b, in particular the details shown in the drawings, are claimed as essential to the invention, whether taken alone or in any combination.

### REFERENCE LIST

10 sensor
11 substrate
12 first side of substrate
13 electrically conducting layer
14 first side of electrically conducting layer
15 passage
20 first insulator
21 second insulator
22 third insulator
23 fourth insulator
25 opening of first insulator
26 opening of second insulator
27 opening of third insulator
28 opening of fourth insulator
30, 30′ soot particle
31 first electrode layer
32 second electrode layer
33 third electrode layer
35 opening of first electrode layer
36 opening of second electrode layer
37 opening of third electrode layer
38 first conductor track
39 second conductor track
40, 40′ first electrode/second electrode of the second level
41, 41′ first electrode/second electrode of the fourth level
42, 42′ first electrode/second electrode of the sixth level
90 undercut
a flow direction
B1 width of passage
B2 width of passage
x preferential axis of electrode
α angle between the normal to the electrode plane and the flow direction
□ angle between the preferential axis and the flow direction
E1 first level
E2 second level
E3 third level
E4 fourth level
E5 fifth Level
E6 sixth level
E7 seventh level

1-18. (canceled)

19. A sensor for the detection of electrically conductive and/or polarizable particles, comprising:
a substrate;
characterized in that on at least one side of the substrate,
in a first level a first structured insulator,
in a second level a first structured electrode layer,
in a third level a second structured insulator and
in a fourth level a second structured electrode layer are arranged either directly or indirectly in such a way that in at least one structured electrode layer and/or one structured insulator at least one opening is formed, which is accessible to the particles to be detected;
wherein the electrode layers each have at least two electrodes or at least two conductor tracks, or a combination of at least one electrode and at least one conductor track.

20. The sensor according to claim 19, characterized in that at least one electrode layer(s) has/have at least two interleaved electrodes or at least two conductor tracks, which are either interleaved or run parallel to each other at least in some regions, or a combination of at least one electrode and at least one conductor track which are interleaved or interwoven with one another.

21. The sensor according to claim 19, characterized in that between the electrodes and/or conductor tracks overlapping openings are formed through at least two levels, which are accessible to the particles to be detected.

22. The sensor according to claim 19, characterized in that a/the structured insulator, at least in some sections, has the structure of a structured electrode layer arranged thereon, in particular of electrodes and/or conductor tracks arranged thereon.

23. The sensor according to claim 19, characterized in that between the substrate and the first structured insulator an electrically conductive layer, in particular a planar metal layer, is formed which in particular covers the substrate in the area of the openings.

24. The sensor according to claim 19, characterized in that between the substrate and the first structured insulator and/or on another side of the substrate and/or in an even-numbered level at least one conductor track, in particular a heating conductor, is formed.

25. The sensor according to claim 19, characterized in that at least one electrode and/or at least one conductor track is/are formed of a conductive metal or an alloy, from a high temperature-resistant metal or a high temperature-resistant alloy, and from a metal of a group comprising platinum metals and an alloy of platinum metals.

26. The sensor according to claim 19, characterized in that on the side of a topmost structured electrode layer facing away from the first structured insulator at least one covering layer is formed, and is formed from one of ceramic, glass, metal oxide, and a combination thereof.

27. The sensor according to claim 19, characterized by the formation of at least one opening as a blind hole.

28. The sensor according to claim 19, characterized in that at least one opening is formed in a linear or meandering form or in the shape of a lattice or spiral.

29. The sensor according to claim 19, characterized in that at least one opening is formed in the form of a longitudinal depression.

30. A sensor system, comprising at least one sensor according to claim 19, and at least one control circuit, which is configured such that the sensor can be operated in any one of a measurement mode, a cleaning mode, and a monitoring mode.

31. A method for controlling a sensor according to claim 19, characterized in that the sensor is operated either in a measurement mode and/or a cleaning mode and/or a monitoring mode.

32. The method as claimed in claim 31, characterized in that in the measurement mode, a change in the electrical resistance between the electrodes and/or conductor tracks of a level of the sensor and/or a change in the capacitances of the electrodes and/or conductor tracks of a level of the sensor is/are measured.

33. Use of a sensor according to claim 19 for the detection of electrically conductive and/or polarizable particles, in particular for the detection of soot particles.

34. The use according to claim 33, characterized in that the flow direction (a) of the particles does not impinge perpendicularly on the plane (x, y) of the structured electrode layer.

35. The use according to claim 33, characterized in that the angle (α) between the normal (z) to the plane (x, y) of the topmost structured electrode layer and the flow direction (a) of the particles is at least 1 degree, preferably at least 10 degrees, particularly preferably at least 30 degrees.

36. The use according to any one of claim 33, characterized in that the angle (β) between the flow direction (a) of the particles and the preferred axes (x) of the electrodes or conductor tracks is between 20 and 90 degrees.
